(19) United States
(12) Patent Application Publication
(10) Pub. No.: US 2015/0332876 A1
(43) Pub. Date: Nov. 19, 2015

(54) MULTI-POINT SWITCHING APPARATUS

(71) Applicant: ALPS ELECTRIC CO., LTD., Tokyo (JP)

(72) Inventor: Tsuyoshi Kikuchi, Miyagi-ken (JP)

(21) Appl. No.: 14/709,857

(22) Filed: May 12, 2015

(30) Foreign Application Priority Data
May 13, 2014 (JP) 2014-099723

(51) Int. Cl. H01H 15/00; H01H 15/10

(52) U.S. Cl. CPC H01H 15/005; H01H 15/10

(57) ABSTRACT

A multi-point switching apparatus includes a continuous common pattern formed on a contact circuit board, equally spaced to-be-switched patterns, and a slider that is brought into sliding contact with both the common pattern and one to-be-switched pattern. The slider is moved to make a switchover in succession. The slider includes a first sliding part and second sliding part that are elastically deformable individually. Each to-be-switched pattern includes a first pattern part placed so as to be brought into sliding contact with the first sliding part and a second pattern part placed so as to be brought into sliding contact with the second sliding part. The first pattern part and second pattern part are electrically connected to each other for each of the to-be-switched patterns. While any of the first sliding part and second sliding part is in a space, the other is in sliding contact with the to-be-switched pattern.

### CLAIM OF PRIORITY

This application claims benefit of priority to Japanese Patent Application No. 2014-099723 filed on May 13, 2014, which is hereby incorporated by reference in its entirety.

### BACKGROUND

1. Field of the Disclosure

The present disclosure relates to a multi-point switching apparatus that enables a stable switching operation while maintaining a continuous electric connection.

2. Description of the Related Art

Multi-point switching apparatuses in which a slider is electrically connected to one of a plurality of patterns to be switched in a selective manner are used in various fields. A multi-point input switching device suitable for input signal switching is disclosed in, for example, Japanese Unexamined Patent Application Publication No. 55-95215.

FIG. 9 illustrates the principle of a switching device 100 described in Japanese Unexamined Patent Application Publication No. 55-95215 as a conventional switching device. FIG. 10 illustrates the principle of a multi-point input switching device 200 described in Japanese Unexamined Patent Application Publication No. 55-95215.

In the conventional switching device 100, a common pattern 122 formed in a continuous shape and a plurality of to-be-switched patterns 123 having a discontinuous shape formed by spaces with a constant interval are formed in parallel on a circuit board. A brush (slider) 124 that is brought into sliding contact with both the common pattern 122 and one of the to-be-switched patterns 123 is also placed on the circuit board. The slider 124 is moved so that it is electrically connected to any one of the plurality of to-be-switched patterns 123, enabling inputs to be sequentially switched.

However, the switching device 100 has been problematic in that when a switchover is made from one to-be-switched pattern 123 to its adjacent to-be-switched pattern 123, the slider 124 is not likely to be electrically connected to either to-be-switched pattern 123. Another problem has been that an electric connection is likely to be made to the two to-be-switched patterns 123, in which case, a short-circuit occurs.

To solve the latter problem, in the multi-point input switching device 200, a common pattern 225 has protrusions 225a to prevent an electric connection from being made to two adjacent to-be-switched patterns 223 at the same time and to reduce variations in connection resistance among the to-be-switched patterns 223. Therefore, a brush 224 is switched to an adjacent to-be-switched pattern 223 through the relevant protrusion 225a, preventing a plurality of to-be-switched patterns 223 from being short-circuited.

Unlike the multi-point input switching device 200 in Japanese Unexamined Patent Application Publication No. 55-95215, however, there have been cases, required for the conventional switching device 100, in which when the brush (slider) 124 is moved, a switching operation is made to the to-be-switched patterns 123 while maintaining a continuous electric connection. To meet this, when a switchover is made from one to-be-switched pattern 123 to its adjacent to-be-switched pattern 123, electric connections must be stably made to the two to-be-switched patterns 123. However, since a space is left between two adjacent to-be-switched patterns 123 in a discontinuous form, an area has been present in which an electric connection between to-be-switched patterns 123 is inevitably broken when the brush (slider) 124 is moved. This has been problematic in that a continuous switching operation cannot be performed. A possible solution to this problem is to reduce the conventional space so that the brush (slider) 124 spans two to-be-switched patterns 123 to make sliding contacts.

However, to reduce a space between two adjacent to-be-switched patterns so that the slider span them to make sliding contacts, part machining precision during pattern fabrication needs to be increased. Even if the space between to-be-switched patterns can be reduced by increasing part machining precision, it has been difficult to perform, in each operation, a stable switching operation while maintaining a continuous electric connection.

### SUMMARY OF THE INVENTION

A multi-point switching apparatus includes a contact circuit board, and a common pattern formed in a continuous shape. the common pattern is placed on the contact circuit board, and a plurality of to-be-switched patterns are arranged along the common pattern. The plurality of to-be-switched patterns have a discontinuous shape formed by spaces with a prescribed interval. A slider is brought into sliding contact with both the common pattern and one of the to-be-switched patterns. The slider is moved to make a switchover in succession. The slider includes a first sliding part and a second sliding part that are elastically deformable individually. Each of the plurality of to-be-switched patterns includes a first pattern part placed so as to be capable of being brought into sliding contact with the first sliding part and a second pattern part placed so as to be capable of being brought into sliding contact with the second sliding par. The first pattern part and second pattern part are electrically connected to each other for each of the to-be-switched patterns; and the first sliding part and second sliding part have a positional relationship in which while any one of them is in sliding contact with the space, the other is in sliding contact with the to-be-switched pattern.

### BRIEF DESCRIPTION OF THE DRAWINGS

FIG. 1 is a block diagram of a multi-point switching apparatus in an embodiment of the present invention;

FIG. 2 schematically illustrates a contact circuit board and a slider;

FIG. 3 schematically illustrates to-be-switched patterns;

FIG. 4A is a plan view of the slider and FIG. 4B is its front view, illustrating the outer shape of the slider;

FIG. 5 schematically illustrates an example of a position to which the slider is moved;

FIG. 6 is a graph indicating values measured by a measuring unit;

FIG. 7 schematically illustrates a first variation of the embodiment of the present invention;

FIG. 8 schematically illustrates a second variation of the embodiment of the present invention;

FIG. 9 illustrates the principle of a conventional switching device; and

FIG. 10 illustrates the principle of a conventional multi-point input switching device.

### DESCRIPTION OF THE EXEMPLARY EMBODIMENTS

### First Embodiment

An embodiment of the present invention will be described below in detail with reference to the drawings. For easy comprehension, dimensions on the drawings have been appropriately changed.

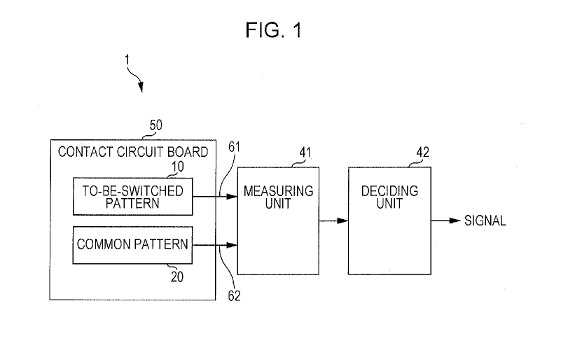

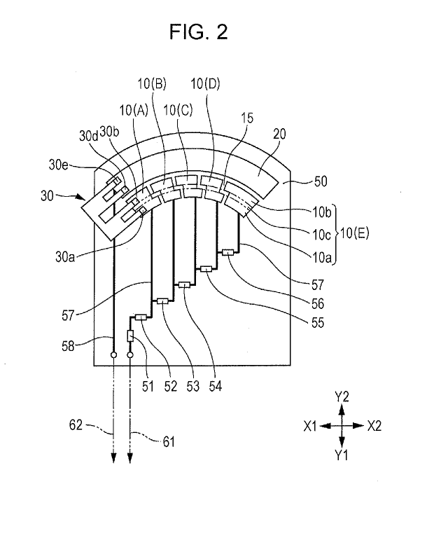

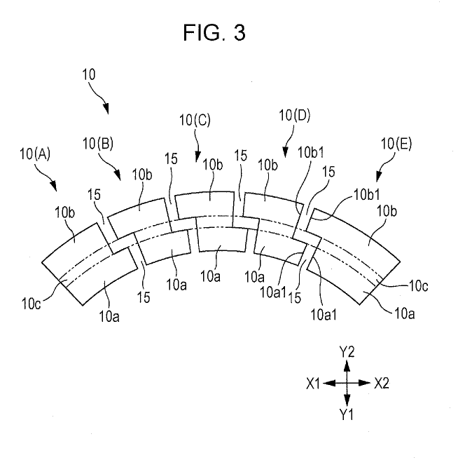

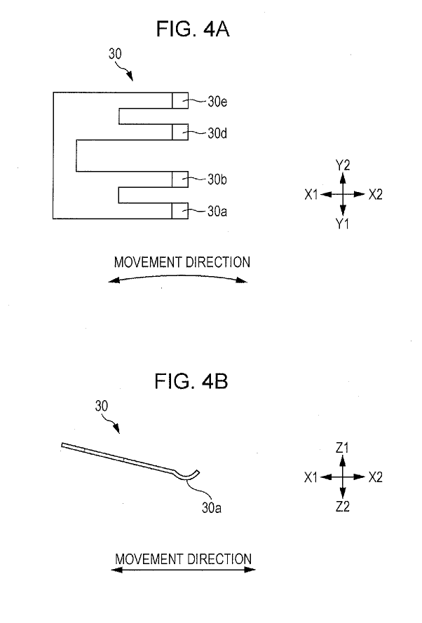

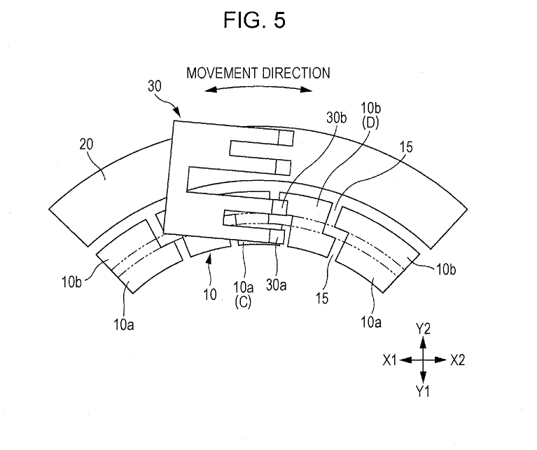

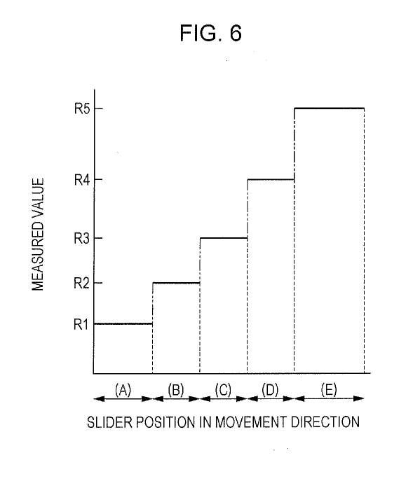

FIG. 1 is a block diagram of a multi-point switching apparatus 1 in an embodiment of the present invention. FIG. 2 schematically illustrates a contact circuit board 50 and a slider 30. FIG. 3 schematically illustrates to-be-switched patterns. FIG. 4A is a plan view of the slider 30 and FIG. 4B is its front view, illustrating the outer shape of the slider 30. FIG. 5 schematically illustrates an example of a position to which the slider 30 is moved. FIG. 6 is a graph indicating values measured by a measuring unit;

The multi-point switching apparatus 1 in this embodiment includes the contact circuit board 50, a measuring unit 41 connected to a to-be-switched pattern 10 and a common pattern 20, which are placed on the contact circuit board 50, and a deciding unit 42 connected to the measuring unit 41, as illustrated in FIG. 1.

On the contact circuit board 50, the common pattern 20 is preferably formed in an arc shape, and a plurality of to-be-switched patterns 10 are preferably circumferentially arranged on a circumference having a diameter smaller than the inner diameter of the common pattern 20, as illustrated in FIG. 2. Each to-be-switched pattern 10 is preferably connected to a first wire 61 with a conductor 57 and resistors intervening between them, each resistor being one of resistors 51, 52, 53, 54, 55, and 56, which have different resistances. Specifically, the to-be-switched patterns 10(A) is connected to the first wire 61 with the resistors 51 and 52 intervening between them, the to-be-switched patterns 10(B) is connected to the first wire 61 with the resistors 51, 52, and 53 intervening between them, the to-be-switched patterns 10(C) is connected to the first wire 61 with the resistors 51, 52, 53, and 54 intervening between them, the to-be-switched patterns 10(D) is connected to the first wire 61 with the resistors 51, 52, 53, 54, and 55 intervening between them, and the to-be-switched patterns 10(E) is connected to the first wire 61 with the resistors 51, 52, 53, 54, 55, and 56 intervening between them. In addition, the common pattern 20 is preferably connected to a second wire 62 with a conductor 58 intervening between them.

Each of the plurality of to-be-switched patterns 10 has a first pattern part 10a, a second pattern part 10b, and a pattern connecting part 10c, which is interposed between the first pattern part 10a and the second pattern part 10b. For each to-be-switched pattern 10, the first pattern part 10a and second pattern part 10b are electrically connected to each other by the pattern connecting part 10c.

The slider 30 has a first sliding part 30a, a second sliding part 30b, a third sliding part 30d, and a fourth sliding part 30e, which are elastically deformable individually. The first sliding part 30a is placed so that its end can be brought into sliding contact with the first pattern part 10a. The second sliding part 30b is placed so that its end can be brought into sliding contact with the second pattern part 10b. The third sliding part 30d and fourth sliding part 30e are placed so that their ends can be brought into sliding contact with the common pattern 20. The slider 30 is supported by a manipulating part (not illustrated) so that a part other than the end is not brought into sliding contact. Due to an operation that manipulates the manipulating part, the slider 30 moves along the common pattern 20, which is in an arc shape, and the circumference on which the plurality of to-be-switched patterns 10 are placed while in sliding contact with the common pattern 20 and to-be-switched patterns 10.

The first wire 61 and second wire 62 are connected to the measuring unit 41. As illustrated in FIG. 1, the measuring unit 41, which measures a resistance between the first wire 61 and the second wire 62, and the deciding unit 42, which outputs a signal determined according to a measurement result obtained from the measuring unit 41, are disposed. The measuring unit 41 is connected to a power supply unit (not illustrated). The measuring unit 41 includes a measurement circuit that measures a resistance from the value of a current that flows when a voltage is applied. The measuring unit 41 may be of a type in which a resistance is measured from the value of a voltage generated when a constant current is flowed from a constant-current power supply unit. The deciding unit 42 is connected to a power supply unit (not illustrated). The deciding unit 42 has a circuit that outputs one of a plurality of types of preset signals according to the value of the resistance measured by the measuring unit 41. The deciding unit 42 is preferably preset so that if the measured resistance exceeds a prescribed range, a signal indicating an abnormality is output.

Next, a relationship between the plurality of to-be-switched patterns 10 and the first sliding part 30a and second sliding part 30b of the slider 30 will be described in detail.

The plurality of to-be-switched patterns 10 have a discontinuous shape formed by spaces 15 with a prescribed interval, as illustrated in FIG. 3. That is, a plurality of first pattern parts 10a are circumferentially arranged with the prescribed space 15 interposed between each two first pattern parts 10a. Similarly, a plurality of second pattern parts 10b are circumferentially arranged with the prescribed space 15 interposed between each two second pattern parts 10b. The end 10b1 of the second pattern part 10b is shifted in a direction in which the slider 30 moves (in the circumferential direction) with respect to the end 10a1 of the first pattern part 10a. The pattern connecting part 10c is shaped so that it does not come into contact with its adjacent to-be-switched patterns 10. The pattern connecting part 10c electrically connects its relevant first pattern part 10a and second pattern part 10b to each other.

The slider 30 is preferably shaped so that the first sliding part 30a and second sliding part 30b are arranged in a direction orthogonal to the movement direction of the slider 30, as illustrated in FIG. 4A. Similarly, the third sliding part 30d and fourth sliding part 30e are arranged in the direction orthogonal to the movement direction. The first sliding part 30a, second sliding part 30b, third sliding part 30d, and fourth sliding part 30e are rounded at their ends and formed like a thin leaf spring as a whole, as illustrated in FIG. 4B. Thus, the first sliding part 30a, second sliding part 30b, third sliding part 30d, and fourth sliding part 30e are elastically deformable individually.

As described above, the slider 30 is compact and is placed so that the end of the first sliding part 30a can be brought into sliding contact with the first pattern part 10a and the end of the second sliding part 30b can be brought into sliding contact with the second pattern part 10b. The first sliding part 30a and second sliding part 30b are arranged in the direction orthogonal to the movement direction of the slider 30.

The first pattern part 10a and second pattern part 10b are preferably placed so that the end 10b1 of the second pattern part 10b is shifted in the movement direction of the slider 30 with respect to the end 10a1 of the first pattern part 10a. In this embodiment, the prescribed space 15 is in a crank shape as illustrated in FIG. 3.

Accordingly, at an arbitrary position in the movement direction of the slider 30, the end of the first sliding part 30a is in sliding contact with the first pattern part 10a or the end of the second sliding part 30b is in sliding contact with the second pattern part 10b, as illustrated in FIG. 5. In the example illustrated in FIG. 5, the end of the first sliding part 30a is in sliding contact with the first pattern part 10a at a position C and the end of the second sliding part 30b is in sliding contact with the second pattern part 10b at a position D. The first sliding part 30a and second sliding part 30b have a positional relationship in which even if the position at which a sliding contact is made is changed in the movement direction of the slider 30, while any one of the first sliding part 30a and second sliding part 30b is in sliding contact with the space 15, the other is in sliding contact with the to-be-switched pattern 10.

Therefore, a stable switching operation by which a continuous electric connection is made is possible at all switching positions in the movement direction of the slider 30.

The space 15 illustrated in FIG. 3 has a shape in which the space 15 is shifted in the mutually opposite movement directions of the slider 30 on the same side as the first pattern part 10a and on the same side as the second pattern part 10b so that the end of the first sliding part 30a and the end of the second sliding part 30b are not brought into sliding contact with the to-be-switched pattern 10 at the same time. The shape of the space 15 is not limited to the shape in FIG. 3; various forms are possible if the space 15 is shifted in the mutually opposite movement directions of the slider 30 on the same side as the first pattern part 10a and on the same side as the second pattern part 10b.

Next, a principle will be described that is used to determine from the value of the measured resistance that the slider 30 is in sliding contact with which of the plurality of to-be-switched patterns 10.

As described above, each to-be-switched pattern 10 is connected to the first wire 61 with the conductor 57 and resistors intervening between them, each resistor being one of the resistors 51, 52, 53, 54, 55, and 56, which have different resistances. The resistances of the first wire 61, conductor 57, and each to-be-switched pattern 10 are negligibly small when compared with the resistances of the resistors 51, 52, 53, 54, 55, and 56. The resistances of the second wire 62, conductor 58, and common pattern 20 are also negligibly small.

The resistances of the resistors 51, 52, 53, 54, 55, and 56 are larger in this order. Since each resistor is connected to the relevant conductor 57 as illustrated in FIG. 2, measured values indicated in FIG. 6 are obtained as resistances at positions in the movement direction of the slider 30.

A resistance R1 in FIG. 6 is a value measured when the resistors 51 and 52 are connected in series; in this state, the slider 30 is in sliding contact with the to-be-switched pattern 10(A) (see FIG. 2) connected to the resistor 52. When the slider 30 is moved to a position at which the slider 30 is no longer in sliding contact with the to-be-switched pattern 10(A) connected to the resistor 52, the resistance is increased to a resistance R2. The resistance R2 is a value measured when the resistors 51, 52, and 53 are connected in series; in this state, the slider 30 is in sliding contact with the to-be-switched pattern 10(B). As the slider 30 is moved, the measured value is similarly increased to resistances R3, R4, and R5. The resistance R3 is a value measured when the resistors 51, 52, 53, and 54 are connected in series; in this state, the slider 30 is in sliding contact with the to-be-switched pattern 10(C). The resistance R4 is a value measured when the resistors 51, 52, 53, 54, and 55 are connected in series; in this state, the slider 30 is in sliding contact with the to-be-switched pattern 10(D). The resistance R5 is a value measured when the resistors 51, 52, 53, 54, 55, and 56 are connected in series; in this state, the slider 30 is in sliding contact with the to-be-switched pattern 10(E). As described above, other resistance components are assumed to be negligibly small.

Thus, when a resistance is measured, it can be decided that the to-be-switched pattern 10 with which the slider 30 had been in sliding contact has been switched. Since the measured value is determined only from the resistances of the resistors 51, 52, 53, 54, 55, and 56, when the measuring unit 41 and deciding unit 42 are operating, there is no worry about mistaken decision.

Unlike this embodiment, if the slider 30 falls into the space 15 during a switchover between to-be-switched patterns 10 and the slider 30 does not thereby come into contact with any one of the to-be-switched patterns 10 at both ends of the space 15, the measured value becomes, for example, an infinite resistance. In this case, it cannot be accurately determined whether switching is in progress or an abnormality has occurred due to a broken wire.

With the multi-point switching apparatus 1 in this embodiment, however, even if the slider 30 falls into the space 15 relevant to one pattern part during movement, the slider 30 is always in sliding contact with another pattern part because another space 15 is at a different position. Therefore, an electric disconnection does not occur. This enables a continuous electric connection to be stably assured without having to increase part machining precision with which, for example, the size of the space 15 is reduced.

In a state in which the slider 30 is in sliding contact to any to-be-switched pattern 10, the measured value is any one of the resistances R1 to R5. Therefore, if a resistance outside this range is measured, it can be determined that there is an abnormality.

Furthermore, the multi-point switching apparatus 1 in this embodiment is structured so that the common pattern 20 in an arc shape is formed on the contact circuit board 50 and the slider 30 is circumferentially moved. In this structure, since the common pattern 20 is formed in an arc shape and the to-be-switched patterns 10 are placed on a circumference, the contact circuit board 50 can also be made compact.

The deciding unit 42 in the multi-point switching apparatus 1 includes a circuit that outputs a signal according to the measured resistance, a single wire is enough as the first wire 61, which electrically connects the plurality of to-be-switched patterns 10 to the measuring unit 41.

Effects in this embodiment will be described below.

The multi-point switching apparatus 1 in this embodiment includes a contact circuit board 50, a common pattern 20 formed in a continuous shape, and a plurality of to-be-switched patterns 10 arranged along the common pattern 20, the plurality of to-be-switched patterns having a discontinuous shape formed by spaces 15 with a prescribed interval. The multi-point switching apparatus 1 further includes a slider 30 that is brought into sliding contact with both the common pattern 20 and one of the to-be-switched patterns 10, the slider 30 being moved to make a switchover in succession. The slider 30 includes a first sliding part 30a and a second sliding part 30b that are elastically deformable individually. Furthermore, each of the plurality of to-be-switched patterns 10 includes a first pattern part 10a placed so as to be capable of being brought into sliding contact with the first sliding part 30a and a second pattern part 10b placed so as to be capable of being brought into sliding contact with the second sliding part 30b. The first pattern part 10a and second pattern part 10b are electrically connected to each other for each of the to-be-switched patterns 10. The first sliding part 30a and second sliding part 30b have a positional relationship in which while any one of them is in sliding contact with the space 15, the other is in sliding contact with the to-be-switched pattern 10.

In this structure, even if the slider 30 falls into the space 15 relevant to one pattern part during movement, the other pattern part is always in sliding contact with another space 15 because it is at a different position, preventing an electric connection from being broken. Therefore, a continuous electric connection can be stably assured without having to increase part machining precision.

With the multi-point switching apparatus 1 in this embodiment, the slider 30 is shaped so that the first sliding part 30a and second sliding part 30b are arranged in a direction orthogonal to the direction in which the slider 30 moves. Furthermore, the to-be-switched pattern 10 is preferably shaped so that the first pattern part 10a and second pattern part 10b are arranged in a direction orthogonal to the movement direction and that the end 10b1 of the second pattern part 10b is shifted in the movement direction with respect to the end 10a1 of the first pattern part 10a.

In this structure, since the first sliding part 30a and second sliding part 30b are arranged in a direction orthogonal to the movement direction of the slider 30, the slider 30 can be made compact.

With the multi-point switching apparatus 1 in this embodiment, the common pattern 20 is formed in an arc shape and the plurality of to-be-switched patterns 10 are circumferentially arranged on a circumference having a different diameter from the common pattern 20.

In this structure, since the common pattern 20 is formed in an arc shape and the to-be-switched patterns 10 are arranged on a circumference, the contact circuit board 50 can also be made compact. Thus, if manipulating units (not illustrated) and a case in which they are accommodated are formed in a cylindrical shape, it is also possible to make the multi-point switching apparatus 1 compact.

With the multi-point switching apparatus 1 in this embodiment, each of the plurality of to-be-switched patterns 10 is preferably connected to a first wire 61 with resistors intervening between them, the resistors having different resistances, and the common pattern 20 is preferably connected to a second wire 62. In addition, the multi-point switching apparatus 1 preferably includes a measuring unit 41, connected to the first wire 61 and second wire 62, that measures a resistance between the first wire 61 and the second wire 62 and a deciding unit 42 that outputs a signal determined according to a measurement result obtained from the measuring unit 41.

In this structure, since resistors having different resistances are connected to each to-be-switched pattern 10, the deciding unit 42 can determine from the measured resistance which of the plurality of to-be-switched patterns 10 is being selected and can output a signal accordingly.

So far, the multi-point switching apparatus 1 in an embodiment of the present invention has been specifically described. However, the present invention is not limited to the embodiment described above. Various changes are possible in the present invention without departing from the intended scope of the present invention. For example, the present disclosure can also be practiced by making variations as described below. These variations are also included in the technical range of the present invention.

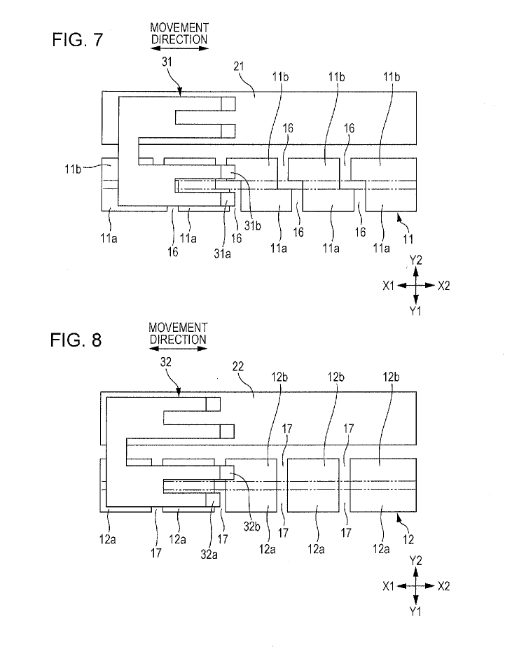

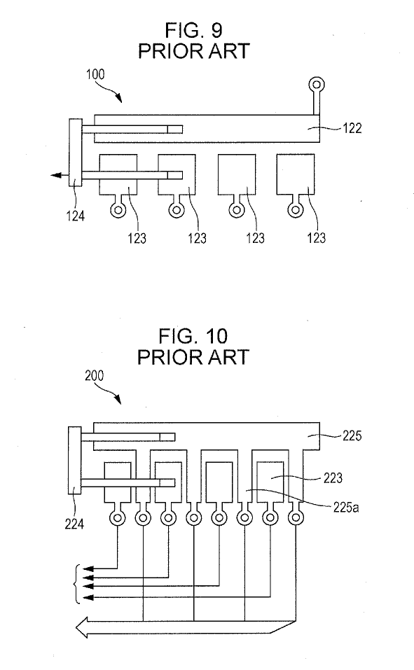

(1) Although, in this embodiment, the common pattern 20 has been formed in an arc shape and a plurality of to-be-switched patterns 10 have been circumferentially arranged on a circumference having a different diameter from the common pattern 20, the common pattern 20 may be changed to a linear shape. FIG. 7 schematically illustrates a first variation of this embodiment. A common pattern 21 in the first variation is formed linearly and a plurality of to-be-switched patterns 11 are formed along the common pattern 21. A slider 31 includes a first sliding part 31a, which is brought into sliding contact with the first pattern part 11a of the to-be-switched pattern 11, and a second sliding part 31b, which is brought into sliding contact with the second pattern part 11b of the to-be-switched pattern 11. The second pattern part 11b is shifted in the movement direction of the slider 31 with respect to the first pattern part 11a. In this aspect, even if the slider 31 falls into a space 16 relevant to one pattern part during movement, the slider 31 is always in sliding contact with another pattern part. Therefore, an electric disconnection does not occur.

(2) Although, in this embodiment, the first sliding part 30a and second sliding part 30b, which are brought into sliding contact with the to-be-switched pattern 10, have been arranged in a direction orthogonal to the movement direction, this arrangement may be changed so that the first sliding part 30a and second sliding part 30b are mutually shifted in the movement direction. FIG. 8 schematically illustrates a second variation of this embodiment. A common pattern 22 in the second variation is formed linearly and a plurality of to-be-switched patterns 12 are formed along the common pattern 22. Each to-be-switched pattern 12 is rectangular. A slider 32 includes a first sliding part 32a, which is brought into sliding contact with the first pattern part 12a of the to-be-switched pattern 12, and a second sliding part 32b, which is brought into sliding contact with the second pattern part 12b of the to-be-switched pattern 12. The second sliding part 32b is shifted in the movement direction of the slider 32 with respect to the first sliding part 32a. In this aspect, even if the slider 32 falls into a space 17 relevant to one pattern part during movement, the slider 32 is always in sliding contact with another pattern part. Therefore, an electric disconnection does not occur.

(3) Although, in this embodiment, the slider 30 has been structured so that it comes into sliding contact with the to-be-switched pattern 10 at the first sliding part 30a and second sliding part 30b, the number of sliding contacts may be 3 or more. Although the to-be-switched pattern 10 has been structured so that it has the first pattern part 10a and second pattern part 10b in correspondence to the number of sliding contacts, a third pattern part may be provided so as to be shifted with respect to the first pattern part and second pattern part.

(4) Although, in this embodiment, the first pattern part 10a and second pattern part 10b have been integrated together with the pattern connecting part 10c interposed between them, they may be formed separately. For example, an electric connection may be made on the rear surface side of the contact circuit board 50 by using an embedded wire that extends through the contact circuit board 50 to its rear surface. Alternatively, the contact circuit board 50 may be formed with a multi-layer board and an electric connection may be made in an internal wiring layer.

What is claimed is:

1. A multi-point switching apparatus comprising:
a contact circuit board;
a common pattern in a continuous shape, the common pattern being placed on the contact circuit board;
a plurality of to-be-switched patterns arranged along the common pattern, the plurality of to-be-switched patterns having a discontinuous shape formed by spaces with a prescribed interval; and
a slider that is brought into sliding contact with both the common pattern and one of the plurality of to-be-switched pattern, the slider being moved to make a switchover in succession; wherein
the slider includes a first sliding part and a second sliding part that are elastically deformable individually,
each of plurality of to-be-switched patterns includes a first pattern part placed so as to be capable of being brought into sliding contact with the first sliding part and a second pattern part placed so as to be capable of being brought into sliding contact with the second sliding part, the first pattern part and second pattern part being electrically connected to each other for each of the plurality of to-be-switched patterns, and
the first sliding part and second sliding part have a positional relationship in which while any one of the first sliding part and second sliding part is in sliding contact with the space, another of the first sliding part and second sliding part is in sliding contact with the to-be-switched pattern.

2. The multi-point switching apparatus according to claim 1, wherein:
the slider is configured so that the first sliding part and second sliding part are arranged in a direction orthogonal to a movement direction in which the slider moves; and
the to-be-switched pattern is configured so that the first pattern part and second pattern part are arranged in a direction orthogonal to the movement direction and that an end of the second pattern part is shifted in the movement direction with respect to an end of the first pattern part.

3. The multi-point switching apparatus according to claim 1, wherein: the common pattern is formed in an arc shape; and
the plurality of to-be-switched patterns are arranged circumferentially on a circumference having a different diameter from the common pattern.

4. The multi-point switching apparatus according to claim 1, further comprising:
a first wire;
a second wire;
a measuring unit; and
a deciding unit; wherein
each of the plurality of to-be-switched patterns is connected to the first wire with resistors intervening between the first wire and the each of the plurality of to-be-switched patterns, the resistors having different resistances, the common pattern is connected to the second wire;
the measuring unit is connected to the first wire and second wire, the measuring unit measuring a resistance between the first wire and the second wire; and
the deciding unit outputs a signal determined according to a measurement result obtained from the measuring unit.
